(19) United States
(12) Patent Application Publication
(10) Pub. No.: US 2010/0240393 A1
(43) Pub. Date: Sep. 23, 2010

(54) SYSTEM AND METHOD FOR SENDING A CURRENT POSITION OF A COMMUNICATION DEVICE

(75) Inventors: YI-CHANG DU, Taoyuan (TW); CHENG-HO CHANG, Taoyuan (TW); SHIH-WEI HSU, Taoyuan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXCONN COMMUNICATION TECHNOLOGY CORP., Taoyuan County (TW)

(21) Appl. No.: 12/603,664

(22) Filed: Oct. 22, 2009

(30) Foreign Application Priority Data
Mar. 21, 2009 (CN) 200910301008.0

(51) Int. Cl. H04W 24/00

(52) U.S. Cl. 455/456.1

(57) ABSTRACT

A system and method for sending a current position of a communication device comprising a global positioning system detects current position of the communication device by the global positioning system when the communication device communicates with a receiving communication device, so as to acquire current position data and communication data from the communication device to the receiving communication device. The system and method further encodes and packs the current position data and the communication data, to generate a data package, and sends the data package to the receiving communication device.

### BACKGROUND

1. Technical Field

Embodiments of the present disclosure generally relate to a positioning system and method, and more particularly to a system and method for sending a current position of a communication device.

2. Description of Related Art

A person may want to use a communication device for location or navigational reasons. In order to do so, the communication device may be integrated with a global positioning system (GPS). When a GPS receiver wants to know a current position of the communication device, current operations of the communication device must be ended to locate and transmit the current position to the GPS receiver. For example, a phone call may be ended to locate the current position of the electronic device. After the current position of the electronic device is transmitted to the GPS receiver, the phone call may be started again. However, ending of the current operations may cause the communication device owner much inconvenience to make phone calls, listen through headsets, check location, listen to talk shows, watch sportscasts, for example.

What is needed, therefore, is a system and method for overcoming the above-mentioned problem.

### BRIEF DESCRIPTION OF THE DRAWINGS

FIG. 1 is a block diagram of one embodiment of a system for sending a current position of a communication device.

FIG. 2 is a block diagram of function modules of a position sending unit included in the communication device of FIG. 1.

FIG. 3 is a flowchart illustrating one embodiment of a method for sending a current position of a communication device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

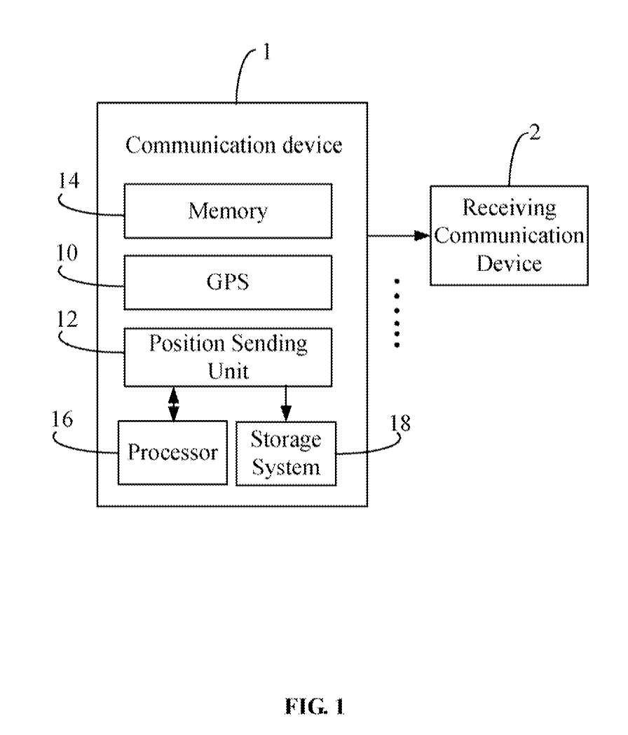

FIG. 1 is a block diagram of one embodiment of a system for sending a current position of a communication device 1. The communication device 1 may communicate with at least one receiving communication device 2 (only one receiving communication device is shown in FIG. 1). In the embodiment, the communication device 1 typically includes a global positioning system (GPS) 10 and a position sending unit 12. The GPS 10 is used for detecting a current location/position of the communication device 1 when the communication device 1 communicates with the at least one receiving communication device 2. The position sending unit 12 is operable to acquire current position data of the communication device 1 using the GPS 10, encode the current position data and communication data, and pack the encoded current position data and the encoded communication data, so as to generate a data package, and send the data package to the at least one receiving communication device 2. In the embodiment, the communication data can be transferred from the communication device 1 to the at least one receiving communication device 2.

The communication device 1 further comprises a memory 14, at least one processor 16, and a storage system 18. The position sending unit 12 may be stored in the storage system 18, and can be executed by the at least one processor 16. The storage system 18 may be a hard disk drive, a compact disc, a digital video disc, or a tape drive. In one embodiment, the communication device 1 may be a mobile phone or a personal digital assistant that is comprising the GPS 10. The receiving communication device 2 may be the same as the communication device 1, which can transmit video data and audio data, and have display functions.

The memory 14 stores the current position data and the communication data. In one embodiment, the current position data may include a latitude, longitude, direction, and map position of the communication device 1. The communication data may include control data, video data, and audio data communicated from the communication device 1 to the at least one receiving communication device 2. In the embodiment, the memory 14 may be a smart media card, a secure digital card, a compact flash card, a multi-media card, a memory stick, an extreme digital card or a trans flash card.

In the embodiment, the control data may be used by the communication device 1 to communicate with the at least one receiving communication device 2. For example, before the communication device 1 communicates with the at least one receiving communication device 2, the control data can detect if the at least one receiving communication device 2 has the same functions as the communication device 1, such as position locating, video capturing, and display features.

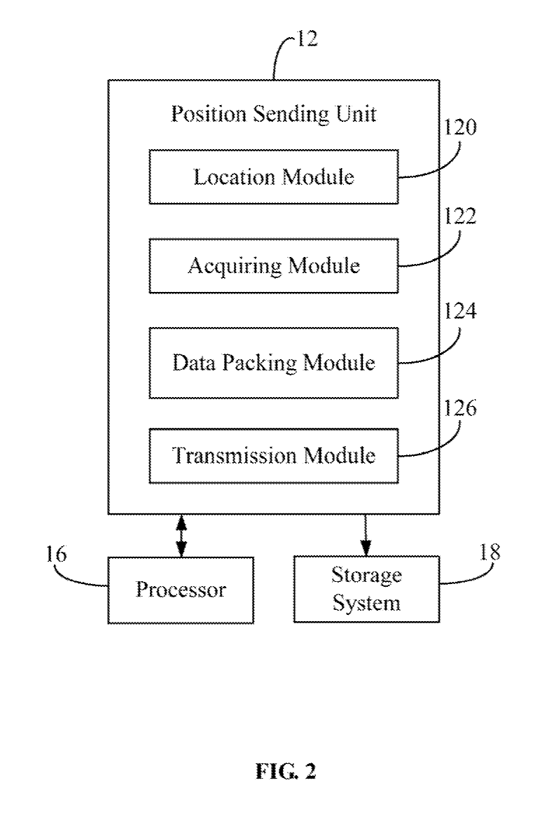

FIG. 2 is a block diagram of function modules of the position sending unit 12. The position sending unit 12 may include a plurality of instructions, which are executed by the at least one processor 16. In one embodiment, the position sending unit 12 may include a locating module 120, an acquiring module 122, a data packing module 124, and a transmission module 126.

The locating module 120 uses the GPS 10 to detect the current position of the communication device 1 when the communication device 1 communicates with a receiving communication device 2.

The acquiring module 122 is operable to acquire current position data of the communication device 1 according to the current position of the communication device 1. In the embodiment, the communication device 1 may be comprising an electronic map. After the GPS 10 detects the current position of the communication device 1, the acquiring module 122 may mark/highlight the current position of the communication device 1 in the electronic map as “province→city→street.”

The data packing module 124 is operable to encode the current position data and the communication data, and pack the encoded position data and the encoded communication data, so as to generate a data package.

The transmission module 126 is operable to send the data package to the receiving communication device 2.

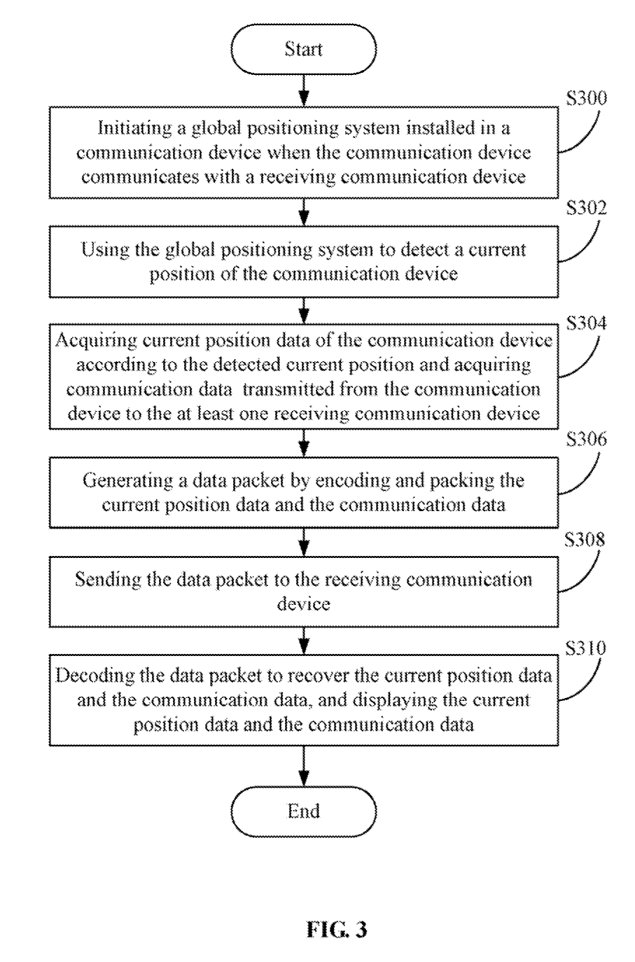

FIG. 3 is a flowchart illustrating one embodiment of a method for seconding a current position of a communication device 1 using the position sending unit 12 that described in FIG. 1. Depending on the embodiment, additional blocks in the flow of FIG. 3 may be added, others removed, and the ordering of the blocks may be changed.

In block S300, when the communication device 1 communicates with a receiving communication device 2, the locating module 120 initializes the GPS 10 installed in the communication device. In the embodiment, the receiving communication device 2 may be the same as the communication device 1, which can transmit video data and audio data.

In block S302, the locating module 120 uses the GPS 10 to detect a current position of the communication device 1.

In block S304, the acquiring module 122 acquires current position data of the communication device 1 according to the detected current position. In the embodiment, the current position data may include the latitude, longitude, direction, and map-position of the communication device 1.

In block S306, the data packing module 124 encodes the current position data and communication data transmitted from the communication device 1 to the receiving communication device 2, and packs the encoded position data and the encoded communication data, so as to generate a data package. In the embodiment, the communication data may include control data, video data and audio data communicated from the communication device 1 to the receiving communication device 2.

In block S308, the transmitting module 126 sends the data package to the receiving communication device 2.

In block S310, the receiving communication device 2 receives the data package, decodes the data package to recover the current position data and the communication data, and displays the current position data and the communication data on a display screen of the receiving communication device 2.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for sending a current position of a communication device comprising a global positioning system, the method comprising:
using the global positioning system to detect the current position of the communication device when the communication device communicates with at least one receiving communication device;
acquiring current position data of the communication device according to the detected current position and acquiring communication data transmitted from the communication device to the at least one receiving communication device;
encoding the current position data and the communication data;
generating a data package by packing the encoded position data and the encoded communication data; and
sending the data package to the at least one receiving communication device.

2. The method as described in claim 1, wherein the communication data comprise control data, video data and audio data.

3. The method as described in claim 1, wherein the current position data comprise a latitude, longitude, direction, and map position of the communication device.

4. The method as described in claim 1, further comprising:
receiving the data package by the communication device;
decoding the data package to recover the current position data and the communication data; and
displaying the current position data and the communication data on the communication device.

5. A storage medium having stored thereon instructions that, when executed by a processor, causing the processor to send a current position of a communication device, the communication device comprising a global positioning system, wherein the method comprises:
using the global positioning system to detect the current position of the communication device when the communication device communicates with at least one receiving communication device;
acquiring current position data of the communication device according to the detected current position and acquiring communication data transmitted from the communication device to the at least one receiving communication device;
encoding the current position data and the communication data;
generating a data package by packing the encoded position data and the encoded communication data; and
sending the data package to the at least one receiving communication device.

6. The storage medium as described in claim 5, wherein the communication data comprise control data, video data and audio data.

7. The storage medium as described in claim 5, wherein the current position data comprise a latitude, longitude, direction, and map-position of the communication device.

8. The storage medium as described in claim 5, wherein the method further comprises:
receiving the data package by the communication device;
decoding the data package to recover the current position data and the communication data; and
displaying the current position data and the communication data on the communication device.

9. A system for sending a current position of a communication device comprising a global positioning system and a position sending unit, the position sending unit comprising:
a locating module operable to use the global positioning system to detect a current position of the communication device when the communication device communicates with a receiving communication device;
an acquiring module operable to acquire current position data of the communication device according to the detected current position and acquire communication data transmitted from the communication device to the at least one receiving communication device;
a data packing module operable to encode the current position data and the communication data, and generate a data package by packing the encoded position data and the encoded communication data;
a transmission module operable to send the data package to the communication device; and
at least one processor that executes the locating module, the acquiring module, the data packing module, and the transmission module.

10. The system as described in claim 9, wherein the communication device is operable to receive the data package, decodes the data package to recover the current position data and the communication data, and display the current position data and communication data.

11. The system as described in claim 9, wherein the communication data comprise control data, video data and audio data.

12. The system as described in claim 9, wherein the current position data comprise a latitude, longitude, direction, and map-position of the communication device.
